(19) United States
(12) Patent Application Publication
(10) Pub. No.: US 2007/0034235 A1
(43) Pub. Date: Feb. 15, 2007

(54) Method and apparatus for washing cars

(75) Inventors: Thomas E. Weyandt, Northville, MI (US); Curtis S. Prater, Warren, MI (US)

Correspondence Address: YOUNG & BASILE, P.C., 3001 WEST BIG BEAVER ROAD, SUITE 624, TROY, MI, 48084, US

(73) Assignee: Belanger, Inc., Northville, MI (US)

(21) Appl. No.: 11/202,563

(22) Filed: Aug. 12, 2005

(51) Int. Cl. B08B 7/04; B08B 9/20; B08B 3/00

(52) U.S. Cl. 134/18; 134/123; 134/25.1

(57) ABSTRACT

An improved vehicle position monitoring system for a carwash bay of the type having an overhead spray type carwash comprising an optical switch establishing a beam path across the wash bay at the forward end thereof, a second optical switch establishing a beam path across the bay at the rear or entry end thereof, the first and second beam paths being longitudinally spaced apart by substantially more than the longitudinal length of a standard passenger vehicle such that a vehicle may be positioned therebetween and allow both beam paths to be fully established. A logic system within the controller interprets the input information to determine whether or not a vehicle is properly positioned within the wash bay and adjust the wash parameters accordingly.

### FIELD OF THE INVENTION

This invention relates to carwash systems and more particularly to a control system which enables the operation of a bay-installed, carwash apparatus only after determining that a car is properly positioned within the confines of the bay.

### BACKGROUND OF THE INVENTION

Bay type carwash systems are often used to wash automotive vehicles in a stationary position within the wash bay. Such systems require far less dedicated space in comparison to tunnel type carwash systems wherein the vehicle is moved from station to station along a linear path where washing, rinsing, and drying procedures are carried out. Bay type carwash systems often use high pressure spray components mounted on one or more arms which can move around a vehicle properly positioned within the bay. The arm or arms direct a high pressure spray against the exterior surfaces of the vehicle. A proper vehicle position is one wherein the vehicle will not. interfere with the programed movement of the spray arm or arms. Various mounting and control systems for the arms, including an overhead system, are possible, one such system compatible with the present invention is illustrated in U.S. Pat. No. 6,372,053 issued Apr. 16, 2003 and assigned to Belanger, Inc. of Northville, Mich.

To determine whether or not the vehicle is in the proper position within the wash bay, it has been common to use a treadle which is engaged, for example, by the left front wheel of the vehicle. Two closely spaced switches in the treadle are closed only when the vehicle is in the proper position. If only the first switch is closed, a sign visible to the driver of the vehicle is illuminated to urge the driver to move a small distance forward until the second switch is closed. If only the second switch is closed, the sign is illuminated to urge the driver to back up a short distance. Only when both switches are closed will a “stop” sign be illuminated.

A system describing an optical treadle is described in U.S. Pat. No. 6,425,407, issued Jul. 30, 2002, to Alan S. Jones and Mark Cuddeback. In that patent, an array of cross beam optical devices is placed at a position near the front or exit end of the wash bay such that the front end of the vehicle can progressively break or interfere with the cross beams. When only the first of the three beams is broken, the driver of the vehicle is urged by illumination of an appropriate sign to move farther forward. When the second beam is also broken, the sign is illuminated to urge the driver to stop. If the driver goes too far forward so as to interrupt or break all three beams, the sign is illuminated to instruct the driver to move backward.

A problem associated with both mechanical and optical treadles as described above is the requirement for precise positioning of the vehicle; i.e., rather small margins of movement or position error are provided in such systems because the switches in the treadle and the beams in the array are closely spaced. This makes it more difficult for the driver of a vehicle to find the appropriate position and such difficulty often lengthens the time it takes to start the washer. This “wasted” time accumulates throughout a busy day and reduces the throughput and revenue generating efficiency of the carwash system It is therefore desirable to provide a system which makes it easier to find the “go” position and tends to enhance throughput efficiency by relaxing the position error margins.

### SUMMARY OF THE INVENTION

The present invention has for its primary objective the relaxation of driver-imposed positioning requirements for a vehicle in a carwash bay which is equipped with a washing system, particularly but not necessarily a vehicle washing system of the high pressure spray type involving an overhead traveler from which one or more spray arms may depend. A carwash system compatible with the present invention is fully described in the aforementioned U.S. Pat. No. 6,372,053, ROLLOVER CARWASH APPARATUS AND METHODS OF OPERATING THE SAME, the entire disclosure of which is incorporated herein by reference. The spray wash system described in the '053 patent comprises a traveler mounted overhead of a wash bay on a rail system which permits both longitudinal and lateral movement of the traveler. A pair of “butterfly” spray arms carrying nozzles depend from the traveler. The arms can move angularly relative to the traveler so as to direct washing and rinsing fluid to the exterior of the vehicle.

In general the objectives of the present invention are accomplished through the provision of a first sensor such as an optical emitter and optical receiver arranged at the near or entry end of a carwash bay and a second sensor similar to the first sensor arranged at the far or exit end of a carwash bay. The terms “entry” and “exit” are used broadly herein to refer to the longitudinally opposite ends of the bay. The bay may be either open at both ends or closed at the far end to require a vehicle to back out after a wash. The longitudinal distance between the two sensors is greater than the length of a standard passenger car but typically less than the length of a specialty vehicle such as a “stretch limousine”. Standard passenger cars are typically about 14 to 18 feet in length, so the first and second sensors may be placed about 20 to 24 feet apart. The positioning requirements imposed on the driver of a vehicle by such a system are greatly relaxed; i.e., the left and right spray arms of the wash system can be used, along with other optional visual cues, to roughly center the vehicle. The first sensor is wired to activate a “pull forward” sign as long as the vehicle is between the emitter and receiver. The sign then displays a “stop” message or the like as soon as the vehicle is fully between the two sensors, and a “reverse” message or the like is displayed if the vehicle pulls far enough forward to come between the emitter and receiver of the second or far end sensor. In short, the driver simply positions the vehicle between the entry and exit sensors and roughly on center. This can usually be achieved much faster than finding a treadle target with one wheel and meeting the fine positioning requirements that such systems impose. Optionally, additional sensors are provided to verify vehicle presence in the bay.

In the preferred embodiment, an “adaptive” feature of the system comes into play as soon as it is determined that a vehicle is roughly positioned between the sensors at the entry and exit ends. The purpose of the adaptive feature is to adjust the travel parameters of the overhead carriage so that the spray arms closely follow the vehicle; i.e., while full longitudinal travel may be needed for an 18 foot vehicle, lesser travel is needed for a 14 foot vehicle. Similarly, cm off-center vehicle may require adjustment of lateral travel. In general, this is accomplished by additional sensors, such as ultrasonic devices, mounted on the overhead traveler and aimed downwardly. Such devices “see” the vehicle to verify its-presence after rough positioning. In addition, such devices can be used to locate the front and rear of the vehicle simply by causing the traveler to move forward and backward from a central “home” position and noting the distance from “home” where the ultrasonic devices see the floor of the bay. This position data is fed to a controller to adjust the length of the spray arm travel during the subsequent washing and rinsing operations.

An additional sensor can be used to locate at least one side of the vehicle and adjust lateral traveler movement as necessary.

It will be appreciated that the terms “car” and “vehicle” are used interchangeably herein and are intended to encompass all types of vehicular bodies including vans, trucks, busses, and even railroad cars.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic plan view of a high pressure spray type carwash system incorporating a vehicle position determining system to enable operation of the carwash system in accordance with the present invention; and

FIG. 2 is a plan view of the system of FIG. 1 washing a stretched vehicle.

FIG. 3 is a plan view of the system of FIG. 1 washing a standard size vehicle.

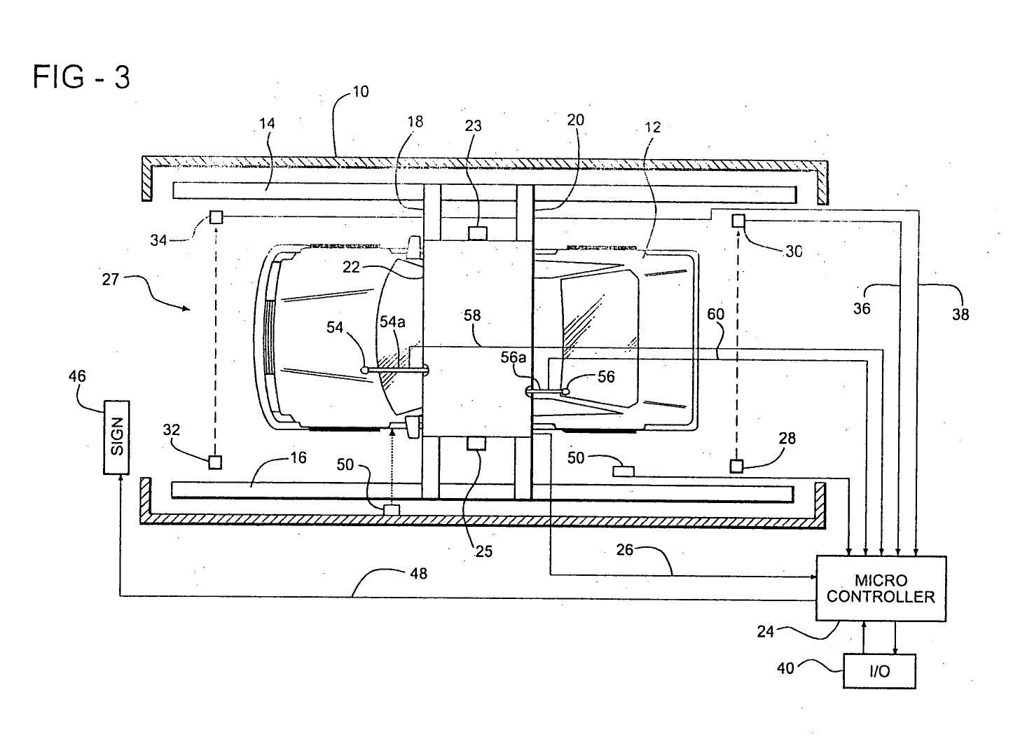

### DESCRIPTION OF THE PREFERRED EMBODIMENT

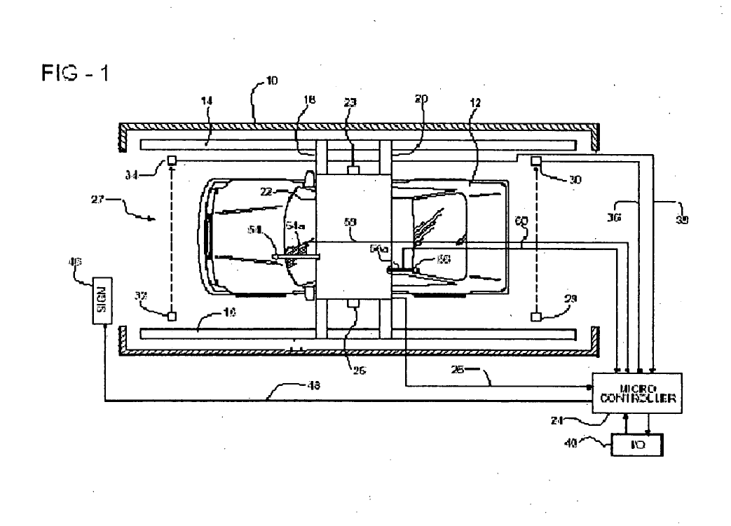

Looking to FIG. 1, there is shown a wash bay 10 of such size and shape as to fully accommodate therein a conventional automotive vehicle 12 such as a passenger car or a light truck. A representative bay length is 24 feet. A carwash system disposed within the bay 10 comprises parallel longitudinal overhead structural members in the form of box beams 14 and 16 supported above the ground by means of vertical posts (not shown) or suspended outwardly from the walls of the wash bay by means of cantilever brackets to eliminate the vertical posts. The longitudinal beams 14 and 16 are longer than the vehicle 12 and are located high enough in the wash bay 10 to be several feet above the roof of the vehicle 12 when positioned within the wash bay 10 as shown. A pair of cross beams 18 and 20 are disposed by means of rollers (more fully described in the Belanger '053 patent) on the longitudinal beams 14 and 16 to support a traveler 22 and permit the traveler to move along the length of the wash bay as required. Traveler 22 contains motors, drive belts, gears, sprockets, and a suspension system for high pressure spray arms having an inverted L-shape and pivotally mounted to the center of traveler 22 as is more fully described in the aforementioned Belanger '053 patent. Spray arms 23 and 25 suspend from the traveler 22 in mirror-image fashion and operate in a butterfly fashion to essentially wrap around the vehicle 12 to wash not only the sides but also the front, rear and horizontal surfaces of the vehicle 12 during a full cycle of operation. A “park” position for the arms places them to the sides of the wash bay where the driver of vehicle 12 may easily place the vehicle roughly centrally between them. Because the spray arms 23, 25 of the carwash system carried by the traveler 22 pass in front of and behind the vehicle during normal operation, it is necessary that the vehicle be positioned in such a way as to not interfere with the movement of the spray arms. In addition, it is desirable to minimize the distance between the spray nozzles and the vehicle exterior for maximum cleaning effect. A microcontroller 24 connected by databus 26 to the internal mechanisms supported by the traveler 22 is provided. The microcontroller is operated in combination with input/output unit 40 containing appropriate displays and program selector input devices such as push buttons. The microcontroller 24 receives signals containing data from the sensors in the system to adjust operating parameters such as travel distances as required to optimize system results.

To establish the positioning protocol of the present invention, a first optical switch comprising an infrared beam emitter 28 and an infrared beam detector 30 is positioned at the entry end of the wash bay 10; i.e., assuming a drive-through wash bay, at a position which is first encountered by the vehicle 12 as it enters the bay. The detector 30 is connected by dataline 36 to the microcontroller 24 so that the sensor output is an input to microcontroller 24.

A second optical switch comprising an infrared beam emitter 32 and an infrared beam detector 34 is positioned at the far or exit end of the wash bay 10. The data output of the detector 34 is connected by data line 38 as an input to the microcontroller 24. The combination of emitter 28 and detector 30 comprises a first light beam switch which is disposed above the floor of the wash bay by a sufficient distance to be intercepted and broken by the front bumper end and body work of the vehicle 12 as it enters the bay. Similarly, the switch made up of the emitter 32 and detector 34 is positioned above the floor of the wash bay 10 near the exit end and far enough forward of the vehicle to establish a light beam which is broken by the vehicle 12 only if it is too far forward in the bay; i.e., further forward than the spray system can accommodate in “normal” operation. The optical switches 28, 30 and 32.34 are slightly farther apart longitudinally than the length of a standard vehicle 12 so as to permit from one to two feet clearance at both the front and the rear of a standard vehicle positioned between the cross beams. It can be seen that “rough” vehicle position information is provided by the cross-bay sensors 28, 30 and 32, 34 alone. As indicated above, the driver uses the spray arms on opposite sides of the bay to achieve a roughly centered position in the bay.

A front ultra sonic device 54 is mounted on the end of an arm 56A projecting forwardly of the traveler 22 and a rear ultra sonic device 56 is mounted on the end of an arm 56A projecting rearwardly from the rear of the traveler 22. Both the front ultra sonic device 54 and the rear ultra sonic device 56 are oriented to look toward the floor of the wash bay 10 and to provide a signal to the microcontroller 24 when a vehicle is present. As hereinafter described, the front ultra sonic device 54 also locates the front of the vehicle 12 by noting the first forward position of the carriage where the vehicle is no longer seen. Similarly the rear ultra sonic 56 can locate the rear of the vehicle 12. These positions are compared to a “home” position number to calculate distance traveled as an indication of the front and rear of the vehicle. The ultra sonic devices 54 and 56 are tuned to provide one output level when the return signal comes from the floor level and another output level when the signal comes from a higher plane i.e., the top or hood or rear deck of a vehicle beneath the sensor. Transition from hood level to floor level as the traveler 22 moves forward locates the front of the vehicle 12 and signals the microcontroller 24 that the front of the vehicle has been located and the microcontroller 24 shortens or lengthens the forward traveler movements as necessary to prevent wasted movement and excessive distances between the spray nozzles and the front surface of the vehicle being washed. The front ultra sonic device 54 is mounted on an arm 54A. The arm ensures that the front of vehicle 12 is located before the traveler 22 reaches the full forward position. The rear ultra sonic device mounted on arm 56A locates the rear of the vehicle 12 and signals microcontroller 24 exactly how far to move the wash arms 23 and 25 rearwardly before wrapping around the vehicle. The front ultra sonic device 54 and rear ultra sonic device 56 position transmit information to the microcontroller 24 by datalines 58 and 60, respectively.

In operation, the entire system is armed when a vehicle approaches; i.e., the emitters 28, 32, the detectors 30, 34, front ultra sonic device 54 and rear ultra sonic device 56 are turned on or activated. The wash components of the carwash are also activated all through proper manipulation of input or output switches at the attendant controller station 40. The microcontroller 24 places the carwash system in an armed and ready condition such that appropriate water/chemical combinations are available and all other necessary conditions for washing vehicles are met. As the vehicle enters the wash bay, it breaks the beam between emitter 28 and detector 30 for as long as it takes the vehicle to move forward far enough to clear the beam path between emitter 28 and detector 30. The signal from the detector 34 to the microcontroller is made before the vehicle arrives, is broken during the passage of the vehicle between the emitter 28 and detector 30 and is made again after the vehicle has passed beyond the beam path. A sign 46 is energized to illuminate a “FORWARD” indicator until the vehicle clears the entry detector 28, 30.

As soon as the vehicle clears sensor 28, 30 but has not reached sensor 32, 34, the sign 46 is energized by the microcontroller 24 to display a “stop” message. If the vehicle 12 goes far enough forward to break the beam of sensor 32, 34, a “reverse” message is indicated.

The signal created by detector 34 remains made as long as the vehicle 12 has not moved far enough forward to intercept the beam path between emitter 32 and detector 24. The signal from front ultra sonic device 54 and rear ultra sonic device 56, however, is broken as soon as the vehicle 12 appears under the sensor. When a vehicle is between the sensors 28, 30 and 32, 34 and is seen by the ultra sonic devices 54, 56. The microcontroller 24 illuminates sign 46 to display “Stop”. In the simplest form of the invention, the wash cycle can be enabled at this time and remain enabled as long as these signal conditions are met. If the vehicle 12 moves too far forward so as to break the beam between the emitter 32 and the detector 34 either after the wash cycle is enabled, a disable situation exists in which the carwash system is shut down. Sign 46 is activated by way of signal line 48 to advise the driver of the vehicle 12 to “REVERSE”. Only when the vehicle is between the sensors 28, 30 and 32, 34 so as to reestablish both beams is the vehicle determined to be in a proper position for activation and continued operation of the carwash system Under these circumstances, the sign 46 is activated to tell the driver of the vehicle 12 to “STOP” ; i.e., inferring that he is in the proper position.

Should the vehicle inadvertently move rearwardly to a sufficient extent to break the beam between the emitter 28 and detector 30, once again the conditions necessary to enable the carwash system are not met and the operation of the carwash system will be suspended. Suspending operation of the carwash system may also comprise moving the spray arms to the laterally outermost position, thereby to prevent damage from a vehicle that is inadvertently moving excessively to the front or the rear during the initiation of the carwash operating cycle. The present invention provides for substantially increased margins of vehicle position acceptance. It eliminates the need for an array of closely spaced multiple sensors at one end of the wash bay.

In the preferred embodiment of the invention, an adaptive feature is employed once the vehicle is properly positioned in the bay but before the wash cycle begins. To activate this feature, the microcontroller 24, having verified that the vehicle is properly positioned, advances the traveler 22 forwardly and rearwardly from a. “home” position to locate the front and rear of the vehicle 12 via the ultra sonic sensors 54 and 56. The microcontroller 24 defines a “home” or “zero” position toward the center of the bay and finds the front and rear of the vehicle as a function of the distances the traveler 22 must move forwardly or rearwardly before the sensors 54 and 56, respectively, see the bay floor. These distances will not be equal unless, by chance. In any event, the microcontroller 24 calculates an exact vehicle length and operates the traveler and arms to closely follow the vehicle outline. Side to side position by fixed sensors or two moving sensors on the lateral traveler.

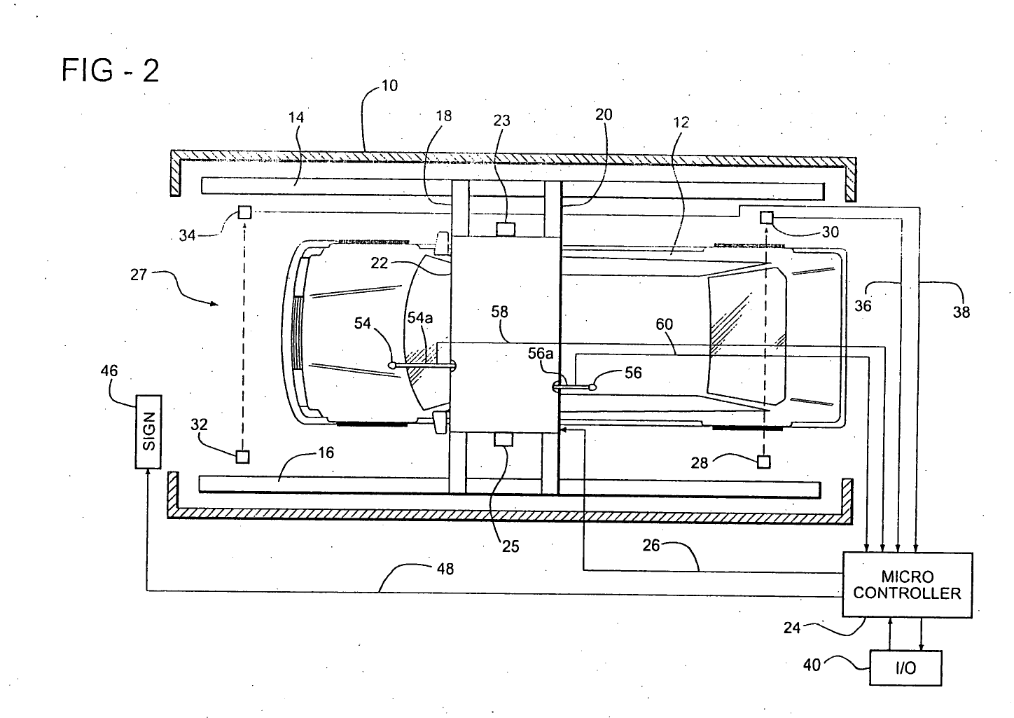

Referring to FIG. 2, a stretched vehicle 12 may also be detected and washed. In the first stage, the length of the vehicle 12 is such as to hold the beam from emitter 28 to detector 30 broken, even though the front ultra sonic device 54 and rear ultra sonic device 56 signal the presence of the vehicle 12. One approach is to activate the sign 46 to signal the driver to continue to move forward until the forward beam is broken. Simultaneously broken (interrupted) signals from detectors 30 and 34 with broken signals from 54 and 56 indicating the presence of a stretched vehicle. The driver is then signaled via sign 46 to “REVERSE” until the forward beam is made (re-established) and then advised to “STOP”. A stretch vehicle can be verified by running the traveler backward and looking for the rear end of the vehicle. If the traveler goes to full rearward stop without finding the vehicle end, then a stretch vehicle is presumed to be in the bay. The wash system may then be activated to perform all operations except the rear wraparound operations.

The following table represents the basic sequence of operations to be programmed:

TABLE 1
Arm system when vehicle approaches.
Entry beam made; no vehicle present. Illuminate “FORWARD”.
Entry beam broken; vehicle present; continue to illuminate “FORWARD”.
Entry beam made again and ultra sonic devices 54, 56 show vehicle
present, illuminate “STOP.”
If entry beam is made, ultra sonic devices show vehicle present
but exit beam broken, illuminate “REVERSE”
Locate front of vehicle.
Locate both sides of vehicle and adjust center line of travel.
Locate rear or stretch vehicle and adjust wash cycle.
Commence wash.
After commencing full wash if forward beam is broken, discontinue
wash, illuminate appropriate sign message to restore vehicle to proper
position.
When wash is finished, store arms and illuminate “FORWARD” sign.
Disarm system when vehicle gone.

Shown in FIG. 30 shows the system washing a standard size vehicle. This embodiment also includes a side ultra sonic device 50. The operation of this embodiment mirrors the operation of the previously disclosed embodiment.

The side ultra sonic device 50 is added to recognize that a side of a vehicle is present within the wash bay 10 and to ensure that the side of the vehicle 12 is within a lateral distance limit established by the longitudinal extending spray arms 23 and 25 coupled to the traveler 22. A vehicle 12 operator uses the dual arms as vertical reference guides to “rough” position the vehicle. When no vehicle 12 is present, the side ultra sonic device 50 transmits a beam to the other side of the baywash 10 which is too far away to cause the ultra sonic device 50 to produce a signal. When a vehicle 12 is present, the side ultra sonic device 50 finds the side of the vehicle 12 and emits a signal pulse that is communicated by way of dataline 52 to the microcontroller 24.

The signal from the detector 30 to the microcontroller 24 is made before the vehicle 12 arrives, is broken during the passage of the vehicle 12 between the emitter 28 and the detector 30 and is made again after the vehicle 12 has passed beyond the beam path. The signal created by detector 32, 34 remains made as long as the vehicle 12 has not moved far enough forward to intercept the beam path between the emitter 32 and the detector 34.

When a vehicle 12 is present under the front ultra sonic device 54 and rear ultra sonic device 56, forward and reverse, pre-wash movement of the carriage locates the front and back of vehicle 12 and data signals communicated by way, of datalines 58 and 60, respectively, as inputs to the microcontroller 24.

The sign 46 remains illuminated to display “FORWARD” until the vehicle breaks the beam from emitter 28. Then the sign 46 is activated to display “REVERSE” until the beam 28,30 is reestablished. As soon as both the front ultra sonic device 54 and the rear ultra sonic device 56 intercept the vehicle 12 and when the vehicle 12 is between the entrance beam 32, 34 and the exit beam 28, 30, and the vehicle 12 is located between the spray arms 23, 25, the sign 46 is activated to display “STOP.” At such time, the car wash system may begin.

By way of summary, it can be seen that the present invention provides two significant operating advantages: (1) it reduces the positioning requirements imposed by the system on the driver, and (2) it provides for an adaptive system operation which locates the vehicle and adjusts the movements of the traveler to optimize the way.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A control for carwash systems of the type associated with a wash bay in which the vehicle is stationary during a washing operation comprising:
a first sensor for detecting the presence of the vehicle at one end of the wash bay;
the second sensor detecting the presence of the vehicle at the other end of the wash bay;
the first and second sensors being far enough apart that a vehicle of substantially standard length can fit between them; and
a controller connected to receive signals from the first and second sensors to enable operation of the carwash system when a vehicle is positioned between the first and second sensors.

2. A system as defined in claim 1 further including a third sensor for detecting presence of the vehicle centrally of the bay;
said third sensor being connected to the controller to enable operation of the carwash system only when a vehicle is present.

3. A system as defined in claim 1 wherein the first sensor comprises an optical emitter and an optical detector, said emitter and detector being arranged to look across the wash bay.

4. A system as defined in claim 1 wherein each of said first and second sensors comprises an optical emitter and an optical detector.

5. A system as defined in claim 2 wherein said third sensor is of the ultra sonic type.

6. A control system for carwashes of the type wherein a longitudinally movable traveler carrying spray arms is mounted over a wash bay of definite length comprising:
a first sensor detecting vehicle presence at one end of the bay;
a second sensor for detecting vehicle presence at the other end of the bay;
third sensor means mounted for moving with said traveler and operative to locate at least the front end of a vehicle disposed substantially between the first and second sensors: and
a controller connected to receive signals from the first, second and third sensors and to adjust the movement parameters of the traveler according to the position of the front end of the vehicle.

7. A method of controlling the operation of the car wash system of the type having spray components which move around a stationary vehicle in a wash bay comprising the steps of
(a) providing a first sensor at one end of the wash bay;
(b) providing a second sensor at the other end of the wash bay;
(c) locating a vehicle between the first and second sensors; and
(d) commencing operations of the carwash system only when the vehicle is between the two sensors.

8. A method of controlling the operation of the carwash system comprising:
an overhead traveler have longitudinal movement capability supporting at least one spray component which moves around a stationary vehicle in a wash bay comprising the steps of:
(a) providing a first sensor at one end of the wash bay;
(b) providing a second sensor at the other end of the wash bay;
(c) positioning a vehicle between the first and second sensors;
(d) providing-a third sensor which moves with the traveler;
(e) using the third sensor to find at least one end of the vehicle in the wash bay; and
(f) adjusting the movement of the traveler according to the location of the end of the vehicle as determined in the foregoing step.

9. Controlling the operation of a bay type carwash system of the type having a traveler which controls the movement of a spray component around at least part of the vehicle which is stationary in the bay comprising the steps of:
(a) using the first sensor system to determine that a vehicle is positioned at least substantially centrally within the bay;
(b) using another sensor system to precisely locate at least one physical feature of the vehicle;
(c) adjusting the movement parameters of the traveler according to the determined location of said physical feature; and
(d) thereafter commencing the wash operation.
